(19) United States
(12) Patent Application Publication
(10) Pub. No.: US 2024/0144674 A1
(43) Pub. Date: May 2, 2024

(54) ESTIMATION OF A CROP COEFFICIENT VECTOR BASED ON MULTISPECTRAL REMOTE SENSING

(71) Applicant: The state of Israel, Ministry of Agriculture & Rural Development, Agricultural Research Org., Rishon Lezion (IL)

(72) Inventors: Offer ROZENSTEIN, Tel Aviv (IL); Josef TANNY, Tel Aviv (IL); Grigorii KAPLAN, Bat Yam (IL)

(21) Appl. No.: 18/279,084

(22) PCT Filed: Feb. 28, 2022
(86) PCT No.: PCT/IB2022/051748

§ 371 Date: Aug. 28, 2023

Related U.S. Application Data
(60) Provisional application No. 63/154,737, filed on Feb. 28, 2021.

(51) Int. Cl. G06V 20/10

(52) U.S. Cl. CPC G06V 20/188; G06V 20/194; G06V 20/13

(57) ABSTRACT

A system and method for estimating a crop coefficient vector (CCV) uses one or more remote sensors that provide multispectral images of a crop growing area. The CCV includes a crop coefficient estimate, K_{C}, and at least one of a leaf area index estimate, LAI, and a crop height estimate, CH. The system includes one or more remote sensing subsystems (RSS); a preprocessor configured to generate harmonized spectral data from multispectral images; a vegetation index (VI) processor to calculate VIs from the harmonized spectral data; a storage medium containing pre-determined regression coefficients; and a CCV processor configured to calculate an estimated CCV. The RSS includes an image sensor mounted on a platform which may be airborne, such as an unmanned aerial vehicle, or space-borne, such as an orbiting satellite. The image sensor includes visual and/or infrared bands.

### CROSS-REFERENCE TO RELATED APPLICATIONS

This application is related to and claims priority from commonly owned U.S. Provisional Patent Application No. 63/154,737, entitled “Estimating Processing Tomato Water Consumption, Leaf Area Index, and Height Using Sentinel-2 and VENμS Imagery”, filed on Feb. 28, 2021, the disclosure of which is incorporated by reference in its entirety herein.

### TECHNICAL FIELD

The present invention relates to remote sensing of crop phenology, and specifically to methods and systems for estimating a temporal sequence of crop coefficients using multispectral remote sensing data.

### BACKGROUND OF THE INVENTION

A variety of methods has been developed for estimating a crop coefficient from image data provided by remote sensors. One such crop coefficient, K_{C}, is defined as a ratio of actual crop evapotranspiration (ET_{C}) to a reference crop evapotranspiration (ET₀). Spatial maps of K_{C} based on empirical image data are superior to standard K_{C} tables for use in precision irrigation systems, insofar as the maps capture the actual crop development including variability within a specific crop growing area. The remote sensors are typically airborne or space-borne platforms carrying high-resolution multispectral imaging cameras.

International Publication number WO 2019/145895 A1 to O. Rozenstein et al., entitled “Method and System for Estimating Crop Coefficient and Evapotranspiration of Crops Based on Remote Sensing”, published on Aug. 1, 2019 (hereinafter '895) teaches methods and systems to estimate crop coefficients of a crop. At least one image sensor system captures a plurality of multispectral images of the crop and image data is derived from the multispectral images. At least one vegetation index of the crop is determined based on image data in at least a first spectral band. The reflectance of the crop monotonically increases and reaches a reflectance of at least 20% for at least one wavelength in the first spectral band. A crop coefficient of the crop is estimated based on the determined at least one vegetation index.

Although the estimation of K_{C} is important to control water consumption, empirical measurements of additional biophysical crop coefficients, and temporal tracking of these coefficients, are needed in order to achieve the overall goal of maximizing crop production.

### SUMMARY OF THE INVENTION

The present invention is directed to methods and systems for estimating a crop coefficient vector (CCV) using multispectral remote sensing data. The vector includes estimates of K_{C} and at least one of a leaf area index (LAI) and a crop height (CH).

According to one aspect of the presently disclosed subject matter, there is provided a system for estimating a crop coefficient vector (CCV) from multispectral images of a crop growing area. The system includes at least one remote sensing subsystem (RSS) for acquiring a multiplicity of multispectral images while passing over the crop growing area; a preprocessor configured to generate harmonized spectral data from one or more of the multispectral images; a Vegetation Index (VI) processor configured to calculate one or more vegetation indices from the harmonized spectral data; a storage medium containing pre-determined regression coefficients; and a CCV processor configured to calculate an estimated CCV which includes a crop coefficient estimate, K_{C}, and at least one of a leaf area index estimate, LAI, and a crop height estimate, CH.

According to some aspects, the RSS includes a platform which is airborne or space-borne.

According to some aspects, the platform is an orbiting satellite, a manned aircraft, an unmanned aerial vehicle, or a drone.

According to some aspects, the RSS includes an image sensor.

According to some aspects, the image sensor includes a visual band and/or an infrared band.

According to some aspects, the visual band includes blue, green, and/or red bands.

According to some aspects, the RSS includes a communication module enabling communication with a ground station.

According to some aspects, the preprocessor is configured to implement an image processing algorithm selected from a group consisting of normalization by a bidirectional reflectance distribution function (BRDF), determination of a nadir BRDF adjustment, compensation of spectral band differences in central wavelength, compensation of spectral band differences in bandwidth, and image registration.

According to some aspects, the preprocessor is configured to implement a signal processing algorithm selected from a group consisting of resampling, interpolation, spline fitting, and minimum least-squares estimation.

According to some aspects, one or more of the vegetation indices is selected from a group consisting of NDVI, GEMI, WDVI, GNDVI, MSAVI, and DVI.

According to some aspects, the regression coefficients include values for a slope and an intercept.

According to some aspects, at least one field measurement sensor is used to determine one or more of the pre-determined regression coefficients.

According to some aspects, at least one field measurement sensor is selected from a group consisting of an anemometer, an infrared gas analyzer, a net radiometer, a soil heat flux sensor, a temperature sensor, and a humidity sensor.

According to some aspects, the system includes two or more remote sensing subsystems and a spectra fusion module (SFM).

According to some aspects, the SFM is configured to perform time-alignment of multispectral images.

According to some aspect, the estimated CCV is a cojoined CCV estimate.

According to another aspect of the presently disclosed subject matter, there is provided a method for estimating a crop coefficient vector (CCV) from multispectral images of a crop growing area. The method includes the following steps: capturing a temporal sequence of multispectral images by at least one remote sensing subsystem (RSS); receiving image data via communication to a ground station; applying image processing to the image data using a preprocessor; calculating vegetation indices (VIs) from the image data, using a VI processor; retrieving pre-determined regression coefficients from a storage medium; and calculating an estimated CCV, which includes a crop coefficient estimate, K_{C}, and at least one of a leaf area index estimate, LAI, and a crop height estimate, CH, using a CCV processor.

According to some aspects, the method returns to the step of capturing a temporal sequence of multispectral images after completing the step of calculating an estimated CCV.

According to some aspects, the method includes updating a record of VI time series which is stored inside the VI processor.

According to some aspects, the method includes updating a record of CCV time series which is stored inside the CCV processor.

### BRIEF DESCRIPTION OF THE DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

FIG. 1: An exemplary spectral signature of a typical vegetation species as acquired by a remote sensor, according to the prior art.

FIG. 2: An exemplary block diagram of a first embodiment of the CCV system of the invention, in which there is a single remote sensor.

FIG. 3: A table of exemplary formulae for several vegetation indices (VIs).

FIG. 4: An exemplary block diagram of the Remote Sensor Subsystem (RSS) of FIG. 2.

FIGS. 5A and 5B: Exemplary tables of the visual (VIS) and near infrared (NIR) spectral bands of two remote sensors.

FIGS. 6A, 6B, and 6C: Exemplary regression plots relating the VIs to the crop coefficients in the CCV.

FIG. 7: An exemplary block diagram of a second embodiment of the CCV system of the invention, in which there are two cojoined remote sensors.

FIG. 8: An exemplary block diagram of the CCV method of the invention.

### DETAILED DESCRIPTION OF THE INVENTION

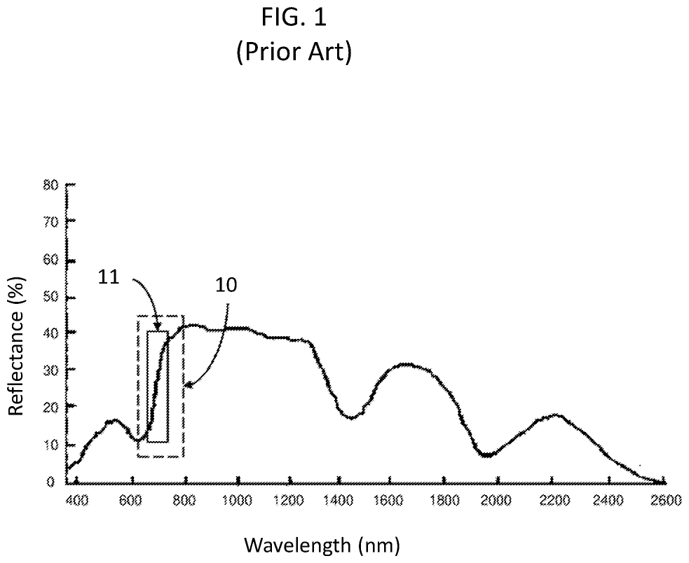

FIG. 1 shows a plot of the spectral signature of a typical vegetation species, as acquired by a remote sensor, based upon FIG. 11 of prior art '895. The plot shows the variation of percent reflectance, plotted on the vertical axis, with the imaging wavelength in nanometers (nm), plotted on the horizontal axis. The wavelength spectrum may include a set of visual (VIS) bands in the region extending from roughly 400 to 750 nm and a set of near-infrared (NIR) bands in the region extending from about 750 to 2500 nm. The location and height of the various peaks in the spectral signature are characteristic of the specific type of vegetation species. Inside rectangle 10, there is a large monotonic increase in reflectivity; and inside the smaller rectangle 11, referred to as the red edge region, the reflectivity varies extremely rapidly. Generally, the red edge region extends from about 680 nm to 780 nm.

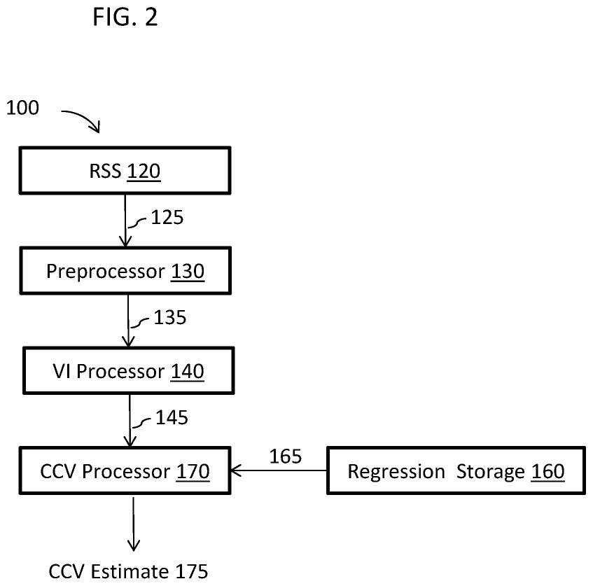

FIG. 2 shows an exemplary block diagram of a CCV system 100 having a single remote sensor, according to a first embodiment of the invention. During a flyover of the crop growing area, Remote Sensing Subsystem (RSS) 120 acquires images and generates a temporal sequence of discretized spectral data 125. The data may be represented, for example, by a three-dimensional array R(λᵢ, tⱼ, rₖ), where R denotes reflectivity and the indices i, j, and k denote discrete sub-bands of the spectral wavelength (λ), discrete instants in time (t), and pixelized spatial locations (r), respectively. The spatial locations are typically distributed as tiles along a line or two-dimensional strip, which overlaps some or all of the crop growing area.

The spectral, temporal and spatial resolution of RSS 120 varies depending upon the imaging equipment used, the revisit time of the flight path over the crop growing area, and the altitude of the sensor. For example, the two Sentinel-2 satellites of the European Space Agency's Copernicus program that fly over Israel at an orbital height of 786 kilometers, provide a collection of spectral bands in the VIS and NIR regions, a combined revisit time of 5 days (assuming cloud-free conditions), and a spatial resolution of 10 meters in VIS and broad NIR bands and 20 meters in the red-edge and narrow NIR bands.

Another example of an RSS 120 is the VENμS micro-satellite that flies over Israel at an orbital height of 720 kilometers. VENμS provides spectral bands similar to those of Sentinel-2, a revisit time of two days, and a spatial resolution of 5-10 meters. There are, of course, many other differences between the two satellite imaging systems, for example with regard to angle of view, field of view (FOV), dynamic range of the radiometric data, and reflectance variations across the mapped area on the ground as reflected in the bidirectional reflectance distribution function (BRDF).

Preprocessor 130 applies various algorithms to “harmonize” the discretized spectral data 125 in order to (a) remove differences in the spatial resolution of different spectral bands, (b) correct for non-uniformities in surface reflectivity within the growing area, (c) perform radiometric corrections such as BRDF normalization and Nadir BRDF (NBAR) adjustment, and (d) correct image registration errors between successive scans of the mapped crop growing area. The preprocessor is configured to perform mathematical algorithms, such as resampling, interpolation, cubic and second-order spline fitting, and minimum least-squares estimation, all of which are familiar to those skilled in the art of digital signal processing for remote sensing.

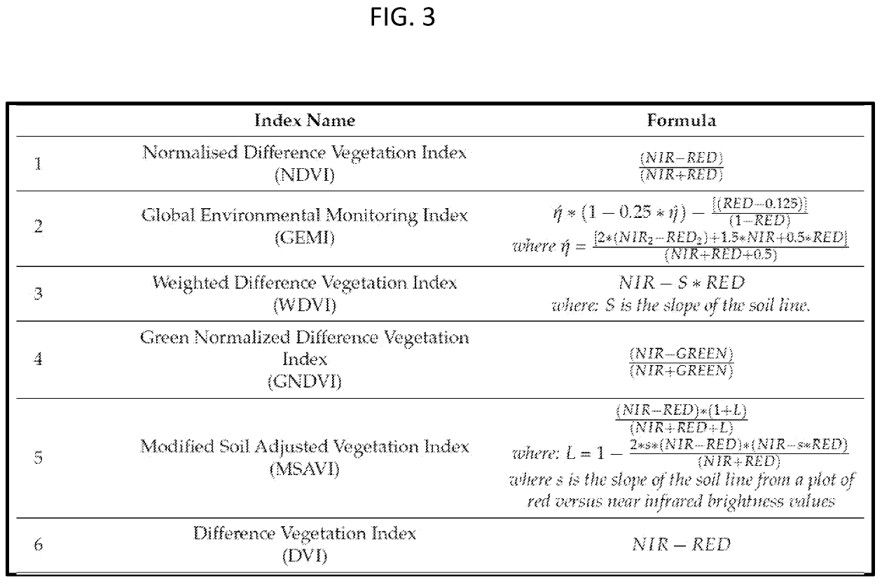

Vegetation Index (VI) processor 140 analyzes the harmonized spectral data 135 and calculates a VI set 145 consisting of a multiplicity of VI values. Formulae for six exemplary VIs, identified as NDVI, GEMI, WDVI, GNDVI, MSAVI, and DVI are found in FIG. 3. The formulae utilize the GREEN, RED, and NIR spectral bands of the harmonized spectral data 135.

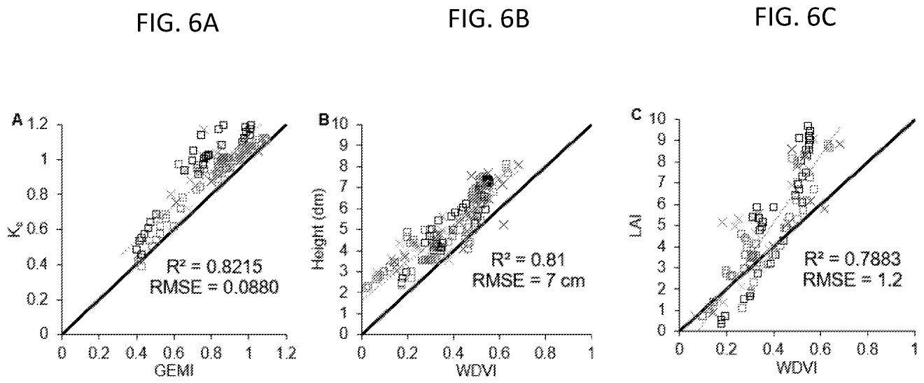

Storage medium 160 contains a database with pre-determined regression coefficients, e.g. slope and intercept values, for linear empirical relationships between the VIs and each of the crop coefficients in the CCV. The linear relationships are found by using ordinary linear regression and/or orthogonal linear regression on empirical data plots, as explained further in reference to FIGS. 6A-6C.

CCV processor 170 in FIG. 2 receives as input: (a) the VI set 145 from VI processor 140; and (b) pre-determined regression coefficients 165 from storage medium 160. The CCV processor combines these inputs to generate a best estimate 175 of the CCV, which includes estimated values of K_{C}, LAI, and CH.

The preprocessor 130, VI processor 140, and CCV processor 170 may be implemented, for example, by general purpose computers, dedicated signal processors, programmable digital processors, or any combination thereof. The storage medium 160 may be implemented by any type of non-volatile digital memory; furthermore, the medium may be integrated as part of one of the processors 140 and 170. In some embodiments, the components 130, 140, and 170 may be integrated into a single main processor.

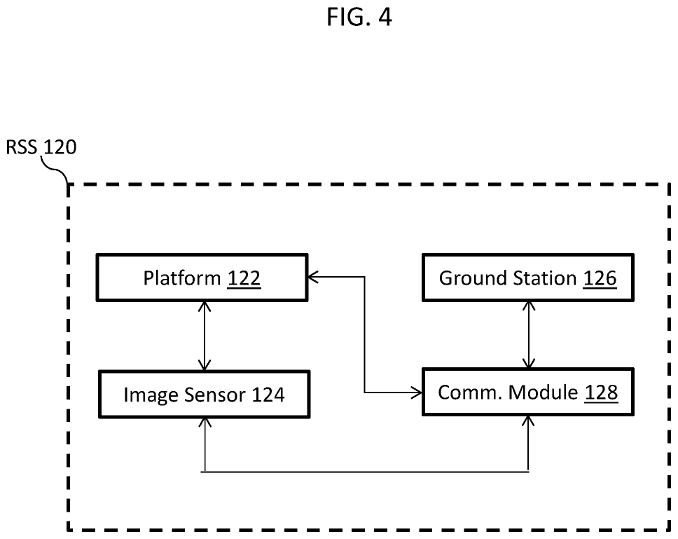

FIG. 4 shows an exemplary block diagram of the RSS 120 of FIG. 2. Platform 122 may be a space-borne satellite, such as Sentinel-2 or VENμS, or an airborne aircraft, such as a manned aircraft, an unmanned aerial vehicle (UAV), or a drone. The latter fly at relatively low altitudes, e.g. from tens to thousands of meters, and generally provide remote sensing with better temporal and spatial resolution, but extending over a smaller mapped area on the ground, as compared with high-altitude orbiting satellite sensors.

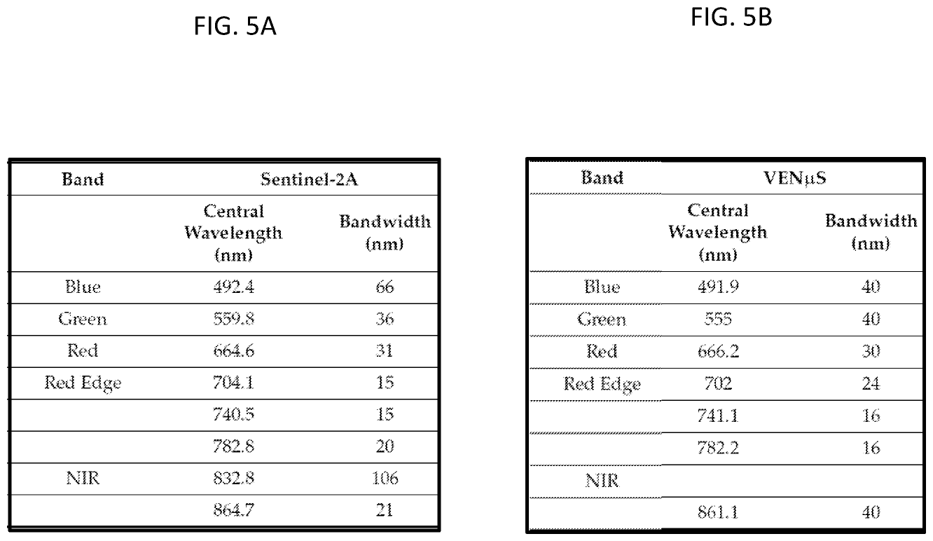

Image sensor 124 is, for example, a multispectral camera. FIGS. 5A and 5B show the VIS and some of the NIR spectral bands of the image sensors carried by one of the Sentinel-2 satellites (Sentinel-2A) and by VENμS, respectively. Note the large variation in the bandwidths of the different spectral bands, as well as the difference in the central wavelengths between the two RSS's.

Communication module 128 in FIG. 4 is configured to receive uplink communication signals from a ground station 126, and to transmit downlink communication signals to the ground station. The uplink communication signals may include, for example, command and control signals to operate non-terrestrial components of RSS 120, such as the image sensor 124. The downlink communication signals include spectral image data captured by the image sensor 124.

FIGS. 6A, 6B, and 6C show exemplary regression plots relating the VIs to the CCV components. Each plot shows a graph of points whose horizontal coordinate is a VI value, e.g. GEMI or WDVI, and whose vertical coordinate is a value of a CCV component, e.g. K_{C}, Height (CH, in decimeters), or LAI, which is measured by a ground-based Field Measurement Station (FMS). The line drawn through the points in each graph is found by linear regression, and the goodness-of-fit is determined by standard R-squared (R²) values and root-mean-square error (RMSE) values. Each line is characterized by a slope and intercept, whose values typically depend on the specific type of vegetation in the crop growing area.

The Field Measurement Station (FMS) is preferably located either inside, or in close proximity to, the crop growing area. The FMS may include a variety of measuring instruments, such as: (a) an eddy covariance (EC) module for measuring ground truth evapotranspiration (ET_{C}); (b) a net radiometer for measuring the balance of incoming and outgoing radiation energy flux; (c) soil heat flux sensors; and (d) temperature and humidity sensors. The EC module typically includes a wind speed anemometer and an infrared gas analyzer for measuring water vapor concentration. The FMS output data includes a ground truth measurement of K_{C} and a measurement of LAI and/or CH.

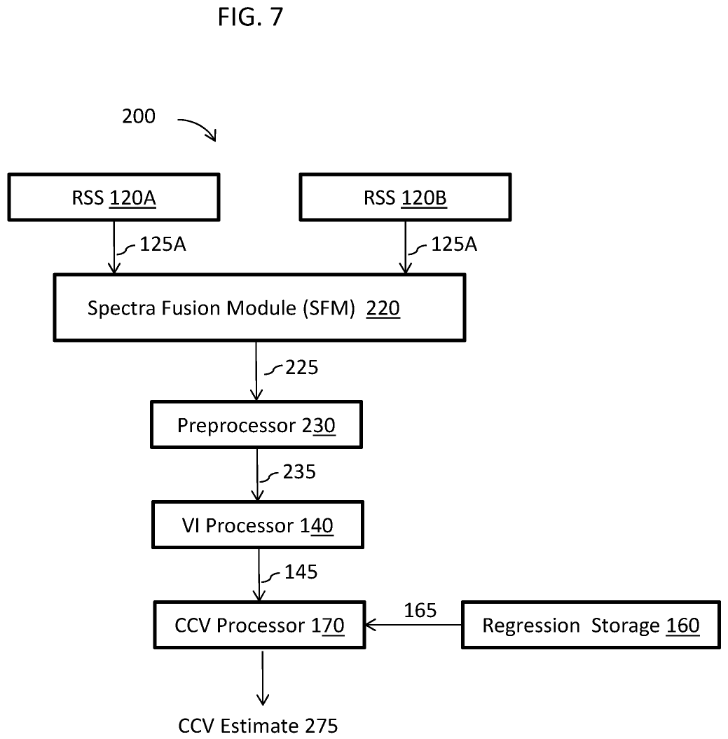

FIG. 7 is an exemplary block diagram of a CCV system 200 in which there are two cojoined remote sensor subsystems, denoted RSS 120A and RSS 120B, according to a second embodiment of the invention. Such a cojoined system has a shorter revisit time than either of the individual RSS's, which is especially advantageous when there are periods of cloud cover that prevent the acquisition of spectral data. Insofar as the orbits and flyover times of 120A and 120B are generally independent, the corresponding temporal sequences of discretized spectral data, 125A and 125B, are asynchronous.

Spectra fusion module (SFM) 220 sorts the temporal sequences of spectral data into chronological order and performs time-alignment between corresponding images in 125A and 125B. Preprocessor 230 receives the combined time-aligned sequence 225 and applies various algorithms to generate cojoined harmonized spectral data 235. The algorithms enable the correction of radiometric and geometric mismatches, e.g. cross-sensor image registration errors, as well as compensation for differences between the cojoined sensors with regard to, for example, the central wavelengths and bandwidths of their spectral bands, their spatial resolutions, and their BDRF normalizations and NBAR adjustments. In order to correct for all of these effects, preprocessor 230 is configured to perform a variety of signal processing algorithms, including, for example, resampling, nearest-neighbour interpolation, spline fitting, and minimum least-squares estimation, both linear and nonlinear.

Cojoined harmonized spectral data 235 enter VI processor 140 and CCV processor 170, which provides processing functions and capabilities similar to those described earlier, with reference to FIG. 2. The CCV processor 170 combines a VI set 145 together with the pre-determined regression coefficients 165 stored in storage medium 160, in order to generate a best cojoined estimate 275 of the CCV. The latter includes estimates of K_{C}, LAI, and CH.

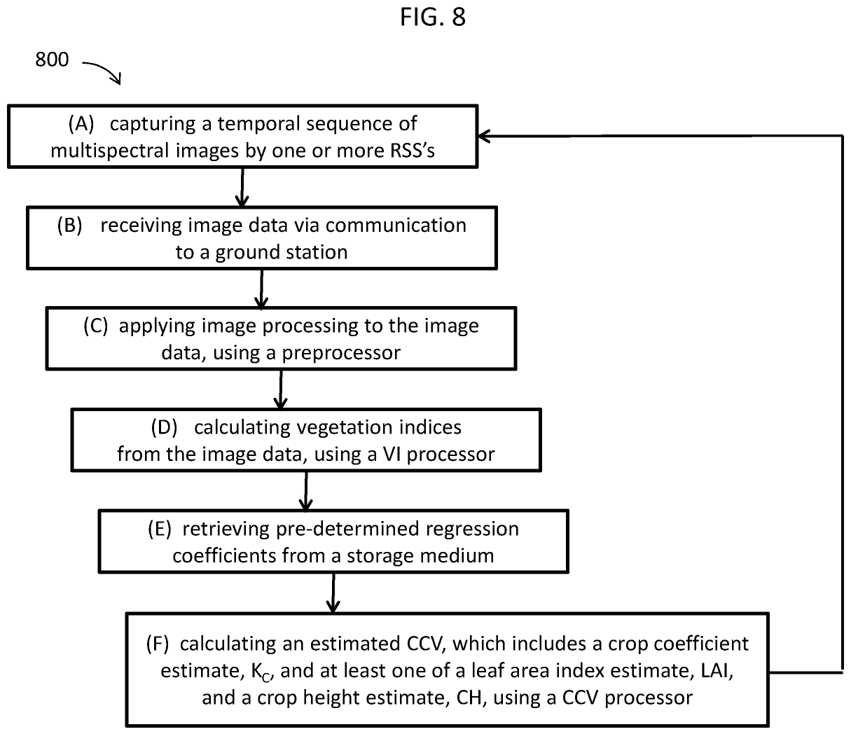

FIG. 8 shows an exemplary block diagram of the CCV method 800 of the invention, which is applicable to both the single and multiple remote sensor configurations, as described in FIGS. 2 and 7, respectively. The steps of the CCV method are as follows:
(A) capturing a temporal sequence of multispectral images by one or more RSS's (120, 120A, or 120B);
(B) receiving image data via communication to a ground station;
(C) applying image processing to the image data, using a preprocessor;
(D) calculating vegetation indices from the image data, using a vegetation index (VI) processor;
(E) retrieving pre-determined regression coefficients from a storage medium; and
(F) calculating an estimated CCV, which includes a crop coefficient estimate, K_{C}, and at least one of a leaf area index estimate, LAI, and a crop height estimate, CH, using a CCV processor.

After step F the method returns to step A, in order to capture additional multispectral images. Step D may optionally include updating a record of VI time series stored inside the VI processor, and step F may optionally include may optionally include updating a record of CCV time series stored inside the CCV processor.

The descriptions of the various embodiments of the present disclosure have been presented for purposes of illustration, but are not intended to be exhaustive or limited to the embodiments disclosed. For example, the embodiment of FIG. 7 may be extended to include more than two remote sensors, in order to generate a combined time-series of spectral data for which the revisit time over the crop growing area is extremely short, e.g. less than 2 days.

Many other modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A system for estimating a crop coefficient vector (CCV) from multispectral images of a crop growing area, the system comprising:
at least one remote sensing subsystem (RSS) for acquiring a multiplicity of multispectral images while passing over the crop growing area;
a preprocessor configured to generate harmonized spectral data from one or more of the multispectral images;
a vegetation index (VI) processor configured to calculate one or more vegetation indices from the harmonized spectral data;
a storage medium comprising pre-determined regression coefficients; and
a CCV processor configured to calculate an estimated CCV comprising a crop coefficient estimate, K_{C}, and at least one of a leaf area index estimate, LAI, and a crop height estimate, CH.

2. The system of claim 1 wherein the RSS comprises a platform which is airborne or space-borne.

3. The system of claim 2 wherein the platform comprises an orbiting satellite, a manned aircraft, an unmanned aerial vehicle, or a drone.

4. The system of claim 1 wherein the RSS comprises an image sensor.

5. The system of claim 4 wherein the image sensor comprises a visual band and/or an infrared band.

6. The system of claim 5 wherein the visual band comprises blue, green, and/or red bands.

7. The system of claim 1 wherein the RSS comprises an RSS communication module enabling communication with a ground station.

8. The system of claim 1 wherein the preprocessor is configured to implement an image processing algorithm selected from a group consisting of normalization by a bidirectional reflectance distribution function (BRDF), determination of a nadir BRDF adjustment, compensation of spectral band differences in central wavelength, compensation of spectral band differences in bandwidth, and image registration.

9. The system of claim 1 wherein the preprocessor is configured to implement a signal processing algorithm selected from a group consisting of resampling, interpolation, spline fitting, and minimum least-squares estimation.

10. The system of claim 1 wherein the one or more vegetation indices is selected from a group consisting of NDVI, GEMI, WDVI, GNDVI, MSAVI, and DVI.

11. The system of claim 1 wherein the regression coefficients include values for a slope and an intercept.

12. The system of claim 1 wherein at least one field measurement sensor is used to determine one or more of the pre-determined regression coefficients.

13. The system of claim 12 wherein the at least one field measurement sensor is selected from a group consisting of an anemometer, an infrared gas analyzer, a net radiometer, a soil heat flux sensor, a temperature sensor, and a humidity sensor.

14. The system of claim 1 comprising at least two remote sensing subsystems and a spectra fusion module (SFM).

15. The system of claim 14 wherein the SFM is configured to perform time-alignment of multispectral images.

16. The system of claim 14 wherein the estimated CCV is a cojoined CCV estimate.

17. A method for estimating a crop coefficient vector (CCV) from multispectral images of a crop growing area, the method comprising the steps of:
(a) capturing a temporal sequence of multispectral images by at least one remote sensing subsystem (RSS);
(b) receiving image data via communication from an RSS communication module to a ground station;
(c) applying image processing to the image data;
(d) calculating vegetation indices from the image data processor;
(e) retrieving pre-determined regression coefficients from a storage medium; and
(f) calculating an estimated CCV, which includes a crop coefficient estimate, K_{C}, and at least one of a leaf area index estimate, LAI, and a crop height estimate, CH.

18. The method of claim 17 wherein the method returns to step (a) after step (f), in order to capture additional multispectral images.

19. The method of claim 17 wherein step (d) additionally comprises updating a record of vegetation index (VI) time series stored inside a VI processor.

20. The method of claim 17 wherein step (f) additionally comprises updating a record of CCV time series stored inside a CCV processor.
